(19) United States
(12) Patent Application Publication
(10) Pub. No.: US 2026/0261166 A1
(43) Pub. Date: Sep. 3, 2026

(54) LAMINATED CORE, MANUFACTURING METHOD FOR THE SAME, AND LAMINATED CORE MANUFACTURING APPARATUS

(71) Applicant: POSCO MOBILITY SOLUTION CORPORATION, Cheonan-si, Chungcheongnam-do (KR)

(72) Inventors: Jung Gyu CHI, Cheonan-si, Chungcheongnam-do (KR); I Gyeong HONG, Bucheon-si, Gyeonggi-do (KR); Jeong Il LEE, Asan-si, Chungcheongnam-do (KR); Sung Jin CHOI, Cheonan-si, Chungcheongnam-do (KR); Suk Jo KANG, Asan-si, Chungcheongnam-do (KR); Yeon Woong KIM, Cheonan-si, Chungcheongnam-do (KR); Myung Su YOON, Cheonan-si, Chungcheongnam-do (KR); Hwi Gyeoung AN, Cheonan-si, Chungcheongnam-do (KR); Byoung Gwan PARK, Cheonan-si, Chungcheongnam-do (KR); Geon Tae SON, Cheonan-si, Chungcheongnam-do (KR)

(73) Assignee: POSCO MOBILITY SOLUTION CORPORATION, Cheonan-si, Chungcheongnam-do (KR)

(21) Appl. No.: 18/878,651

(22) PCT Filed: Sep. 6, 2023
(86) PCT No.: PCT/KR2023/013318

§ 371 Date: Dec. 24, 2024

(30) Foreign Application Priority Data
Sep. 8, 2022 (KR) 10-2022-0114201

(51) Int. Cl. H02K 1/16; H02K 15/0273

(52) U.S. Cl. CPC H02K 1/16; H02K 15/0273

(57) ABSTRACT

Disclosed are a laminated core formed by stacking of laminas, a method and an apparatus for manufacturing the same. The laminated core includes a first lamina and a third lamina provided in parallel, and a plurality of second laminas having a hole into which a first protrusion of the first lamina is fitted and a protrusion fitted into a third hole of the third lamina. Each of the second laminas is provided between the first lamina and the third lamina and connects the first lamina and the third lamina, and the hole and the protrusion of the second lamina formed at different positions. According to the present invention, the interference between the laminas can be minimized or prevented. Therefore, the thickness deviation of a laminated core may be remedied, and the parallelism, perpendicularity, and flatness of the laminated core may be improved.

### TECHNICAL FIELD

The present invention relates to a laminated core, a method and an apparatus for manufacturing the same, and more particularly to a laminated core including laminas coupled by locking protrusion (Projections) on a first lamina inserted into a locking hole (through hole) of a second lamina, a method and an apparatus for manufacturing the same.

### BACKGROUND ART

In general, an iron core is used in a rotating device such as a motor or a generator, or in an ignition plug. Recently, a core having a structure in which thin plates i.e., laminas having a predetermined shape are stacked and coupled is used and called a laminated core.

A part of a finished core, i.e., a split core, can also be the laminated core, and these split cores may be joined together to form the finished core.

As the laminated core manufacturing method that the laminas are laminated/integrated to form the laminated core, a tab fixing method using continuous coupling between interlocking tabs i.e., interlocking protrusions (projection) and an adhesion method where the laminas are integrated via adhesive are known.

As an example of the adhesion method coupling the laminas using adhesive, i.e., adhesive laminated core manufacturing technology, methods for manufacturing a laminated core by applying the adhesive to the surface of a metal strip supplied to an apparatus (die) for manufacturing a laminated core and blanking the metal strip are disclosed in Korean Registered Patent No. 10-1566491 and Japanese Patent Publication No. H5-304037, etc.

The laminas are formed by blanking of the metal strip, are stacked in an inner space of a stacking die (lamination unit) in an up and down direction and integrated together.

Meanwhile, a lamina of a laminated core manufactured by the tab fixing method has an embossed protrusion, i.e., the interlocking tab (caulking protrusion) for coupling the laminas.

The tab fixing method is known in the art of the laminate core, in which the embossed protrusion couples the laminas.

### DISCLOSURE

### Technical Problem

It is an object of the present invention to provide a laminated core including a lamination structure in which interlocking tabs inserted into through holes to couple the laminas, the lamination structure being repeated over multiple layers, in order to minimize or prevent the occurrence of a gap between laminas due to interference of interlocking tabs, a method and an apparatus for manufacturing the same.

Another object of the present invention is to provide a laminated core having a coupling structure where the interlocking tabs are inserted into the counter holes is repeated to integrate the laminas.

Yet Another object of the present invention is to provide a method and an apparatus for manufacturing the laminated core having the lamination structure described above.

### Technical Solution

An embodiment of the present invention provides a laminated core formed by stacking of laminas. The laminas may include a first lamina and a third lamina provided in parallel, and a plurality of second laminas having a hole into which a first protrusion of the first lamina is fitted and a protrusion fitted into a third hole of the third lamina. Each of the second laminas is provided between the first lamina and the third lamina and connects the first lamina and the third lamina, and the hole and the protrusion of the second lamina formed at different positions.

Another embodiment of the present invention provides a laminated core formed by stacking of laminas including a laminated body including first laminas having a first hole and a first protrusion and second laminas, each of the first laminas having a first hole and a first protrusion formed at different positions, each of the second laminas having a second hole and a second protrusion formed at different positions, the first and second protrusions protruding in a same direction. The first hole and the second protrusion are formed on the same line, the first protrusion and the second hole are formed on the same line, the first lamina and the second lamina are alternately stacked, and the first laminas divided by the second laminas.

Yet another embodiment of the present invention provides a method for manufacturing a laminated core. The method comprises (a) step of stacking the second lamina on a cover lamina provided inside a stacking die and forming a lower laminate having a structure where the second lamina are fixed on the cover lamina by fitting, and (b) step of alternately stacking at least one layer of the first layer and at least one layer of the second layer on the lower laminate a predetermined number of times.

Additional embodiment of the present invention provides an apparatus for manufacturing a laminated core. The apparatus comprises an embossing unit configured to press different blanking planned areas of a metal strip to form the first protrusion and the second protrusion with embossed shapes on the metal strip, a piercing unit provided upstream or downstream of the embossing unit or in the same area as the embossing unit in a transfer direction of the metal strip and configured to form the first hole in a blanking planned area for forming the first protrusion and the second hole in a blanking planned area for forming the second protrusion, respectively, and a blanking unit configured to form the first laminas and the second laminas by blanking the metal strip, at predetermined times.

### Advantageous Effects

According to the present invention, the interference between the protrusions can be minimized or prevented. Therefore, the thickness deviation between regions of a laminated core may be remedied, and the parallelism, perpendicularity, and flatness of the laminated core may be improved. In addition, according to the present invention, the deformation of the protrusion may be remedied, and the number of layers fixed to one protrusion may be increased by increasing the height of the protrusion, and separation between the layers may be remedied.

### DESCRIPTION OF DRAWINGS

The present invention can be well appreciated with reference to drawings described below jointly with a detailed description for exemplary embodiments of the present invention to be described below, in which

FIGS. 1A to 1C are views for describing an example of a lamina coupling structure applicable to embodiments of a laminated core according to the present invention;

FIG. 2 is a sectional view for illustrating a connection of laminas for embodiments of a laminated core;

FIG. 3A shows examples of laminas for one embodiment of a laminated core;

FIG. 3B shows a lamination structure of one embodiment of a laminated core shown in FIG. 3A;

FIG. 4 shows a lamination structure of another embodiment of a laminated core;

FIG. 5 shows a lamination structure of yet another embodiment of a laminated core;

FIG. 6 shows one embodiment of an apparatus for manufacturing the lamination structure shown in FIG. 3B;

FIG. 7 is a view illustrating elevation structure of a piercing punch for the apparatus of FIG. 6;

FIG. 8 shows an example of a processing flow of a metal strip using the apparatus shown in FIG. 6;

FIG. 9 shows another embodiment of an apparatus for manufacturing the lamination structure shown in FIG. 2;

FIG. 10 shows an example of a processing flow of a metal strip using the apparatus shown in FIG. 9;

FIG. 11 shows another layout example of an embossing pin and a piercing punch for an apparatus for manufacturing the lamination structure shown in FIG. 2;

FIG. 12 shows a specific embodiment of a laminated core having the lamination structure shown in FIG. 3B;

FIGS. 13 to 15 show laminas for manufacturing the laminated core shown in FIG. 12; and

FIGS. 16 to 19 show additional example of lamination structures for the present invention.

### BEST MODE

Hereinafter, preferred embodiments of the present invention are described with reference to the accompanying drawings. In describing the embodiments, the same name and the same reference numeral are used with respect to the same element and repetitive description thereto will be omitted. And the descriptions of technologies well known in the art are omitted or minimized.

Embodiments of a laminated core according to the present invention are a multilayer structure formed by lamination of laminas L.

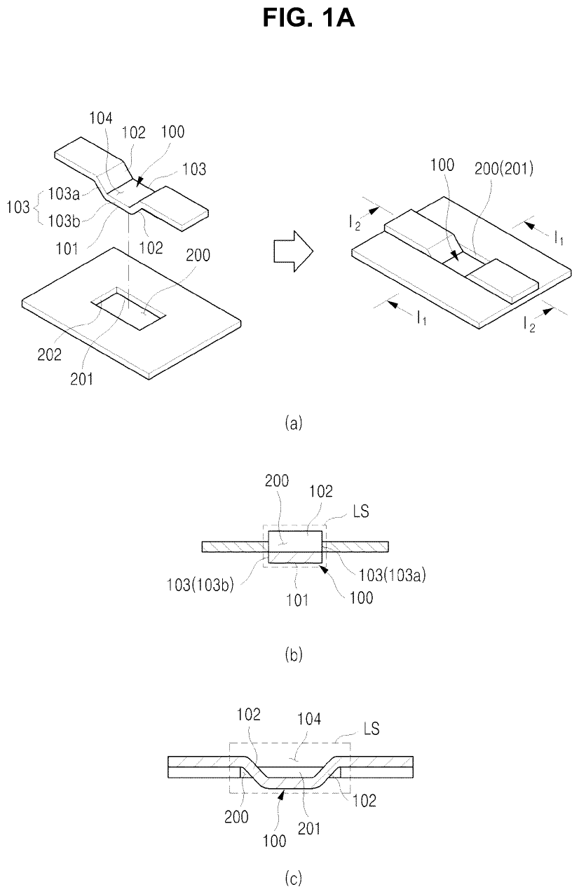

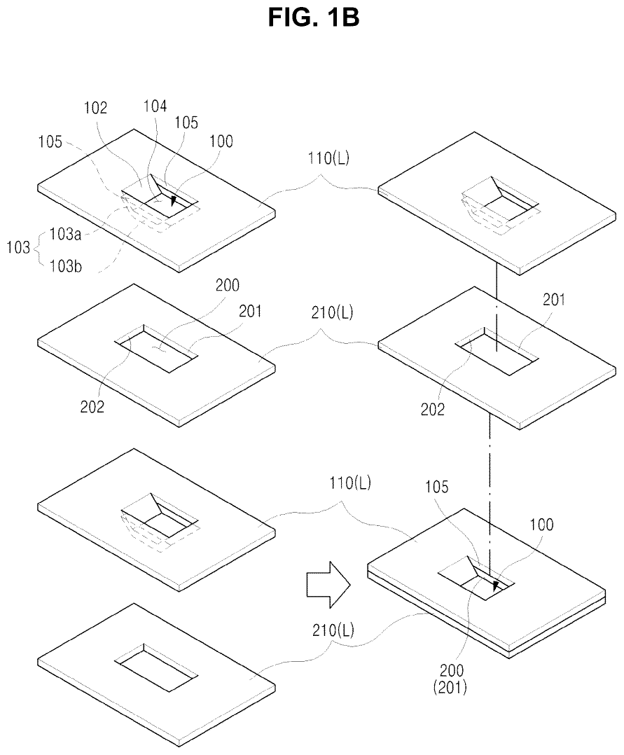

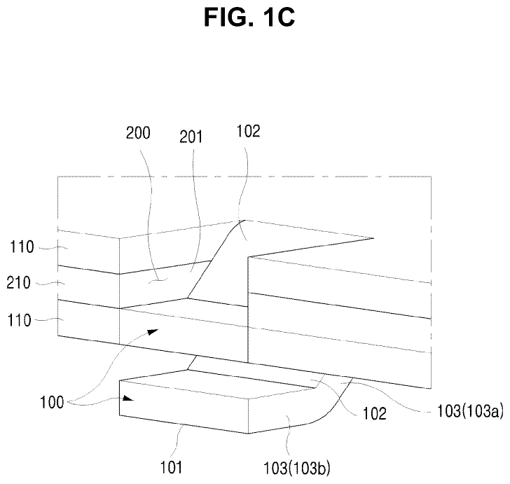

Referring to FIGS. 1A to 1C, embodiments of the laminated core include adjacent laminae 110 and 210 that are adjacently overlapped and fixed by the connection of paired protrusions 100 and holes 200.

In the adjacent laminas, the protrusion 100 is formed on a first lamina 110, and the hole 200 is formed through a second lamina 210 in the thickness direction such that the protrusion 100 fits into the hole 200.

The protrusion 100 is formed to protrude from one side (bottom side) of the first lamina, and the hole 200 passes through second lamina 210 in the thickness direction. For example, the hole has a shape formed by piercing processing.

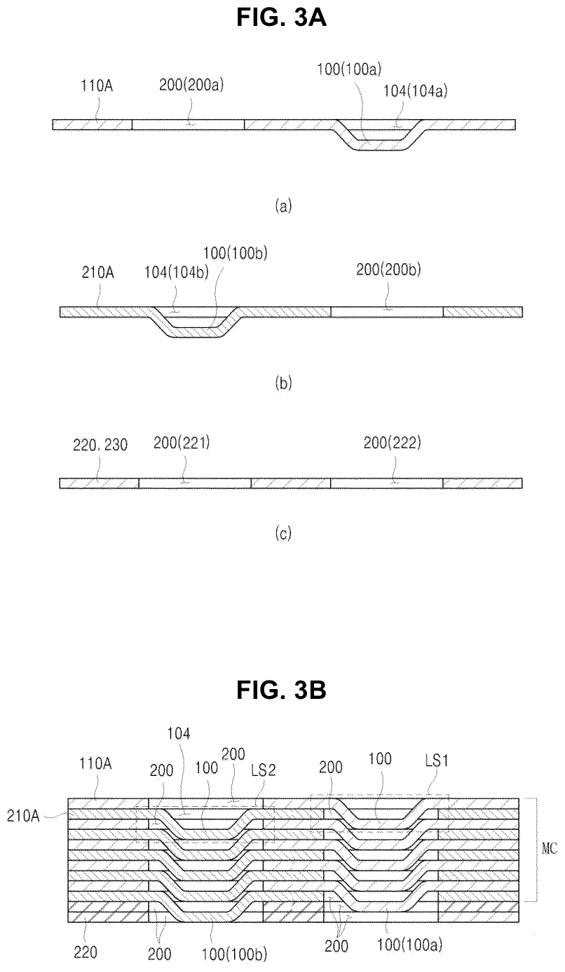

The protrusion 100 is inserted into the hole and connects the adjacent laminas 100 and 200 and forms a lamination structure LS, LS1, and LS2 coupling the adjacent laminas and repeated over multiple layers of the laminated core. Various examples of lamination structure for coupling the adjacent laminas, are shown in FIGS. 3B, 4, 5, and 16 to 19.

In other words, the embodiments of the laminated core have a layered structure in which the lamination structure LS formed by fitting the protrusions 100 into the through holes 200 and connecting the adjacent laminas is repeated over the multiple layers. The lamination structure LS can be repeatedly formed regularly and successively, or it may repeat with regular or irregular intervals along the thickness direction of the laminated core.

The protrusion 100 may have a connection portion 102 configured to connect a tip 101 of the protrusion to any lamina having the protrusion and a fitting surface 103 configured to form side edges of the tip 101 and the connection portion 102 and fitted into the hole 200.

More particularly, the fitting surface 103 includes a first fitting surface 103a forming the edges of the connection portion 102 and a second fitting surface 103b forming the edges of the tip 101. In this embodiment, the protrusion 100 narrows toward the tip 101 and may has a pair of the connection portion 102 with an inclined shape.

The protrusion 100 has an embossed shape having a concave rear surface, and for example, the protrusion 100 may be formed by embossing process pressing a material (metal strip). Accordingly, the protrusion 100 has a convex portion protruding from one surface of the lamina and a concave portion 104 formed in a rear surface of the protrusion 100.

Any lamina having the protrusion 100A may include an attaching surface 105 configured to form an inlet edge of the concave portion 104 and to be attached to the convex part of another protrusion inserted into the concave portion 104 by fitting. The attaching surface 105 and the fitting surface 103 may be shear surfaces split to have misaligned shapes.

Next, the piercing hole 200 is a hole into which the protrusion 100 is inserted, and the protrusion 100 may be inserted into the hole 200 by loose fitting or interference fitting.

Specifically, a border of the hole 200 receiving the protrusion 100 has a counter surface 201 to which the protrusion 100 is fitted. The counter surface 201 may form both edges of the hole 200 attached to the attaching surface 105 on the same plane with the counter surface.

For example, when the protrusion 100 is inserted into the hole 200, the first fitting surface 103a contacts the counter surface 201, and the second fitting surface 103b contacts the fitting surface 105 of the leading protrusion. A spaced surface 202 configured to prevent interference between the connection portion 102 and the hole 200 is formed on the edge of the hole 200.

When the protrusion 100 is fitted to the hole 200 by fitting, a gap is formed between the connection portion 102 and the space surface 202. The counter surface 201 and the spaced surface 202 may be shear surfaces formed on a metal strip by piercing.

In this embodiment, the hole 200 is a quadrangular hole, wherein two parallel edges of the hole form the counter surface 201 and the rest two edges form the spaced surface 202.

Although the protrusion 100 shown in FIGS. 1A to 1C, is a quadrangular protrusion (quadrangular embossing), the shape of the protrusion is not limited to the shape illustrated herein, for example, the shape of the protrusion may have vertical cross-sections corresponding to the cross-sections in (b) and (c) of FIG. 1A, and elliptical or circular concave recess in top views, various other shapes such as an elliptical/circular shape are possible, and it is obvious that the shape of the hole may be changed in response to the shape of the protrusion. The tip 101 of the protrusion shown in FIG. 1 is flat but is not limited thereto, and other shapes such as a downwardly curved surface or a sharped shape are also possible, but a flat shape is preferred to increase fitting force.

The protrusion 100 may pass through at least one layer of lamina having the hole 200 formed on the same line with the protrusion 100, be inserted into a concave portion 104 of a leading protrusion located thereunder, and be attached to its fitting surface 105. And such the lamination structure LS may be repeated to couples a plurality of laminas.

The protrusions 100 forming the lamination structure LS in the multiple layers of the laminated core can be successively connected in a row to fix the laminas together. More particularly, when the protrusion 100 pass through at least one hole 200 and is inserted into the concave portion 104 of the next protrusion, whereby the protrusions are successively connected and fixed in a row.

The number of laminas coupled to one protrusion may be varied depending on the protruding height of the protrusion 100. If the height of the protrusion is greater than the thickness of the hole, for example, N times the thickness of the hole (N being a natural number), N sheets of the laminas with the hole may be successively fixed to one protrusion 100. The height of the protrusion 100 may vary on the depth of embossing.

As an example, when the height of the protrusion 100 is twice the thickness of the hole, the protrusion 100 may pass through one sheet of lamina with the hole 200 and may be fitted to the concave portion 104 of a protrusion formed in the leading lamina, and the hole 200 may prevent interference between the protrusions.

For convenience of description, when the protruding direction of the protrusions 100 is a downward direction, an upper one of a pair of protrusions directly connected to each other is called a upper protrusion, and a lower one of the pair of protrusions is called a lower protrusion, a lower surface of the upper protrusion is not in contact with the concave portion 104 of the lower protrusion, therefore the occurrence of a gap at the interface between adjacent laminated laminas L may be prevented. The first fitting surface 103a of the upper protrusion is in contact with the counter surface 201 of the piercing hole, and the second fitting surface 103b of the upper protrusion is in contact with the fitting surface 105 of the lower protrusion.

According to the above connection structure, the protrusions 100 may be successively coupled together in a back-to-back connection, the connection structure can repeat at regular or irregular intervals along the thickness direction of the laminated core, thereby minimizing or preventing interlayer gaps within the laminated core.

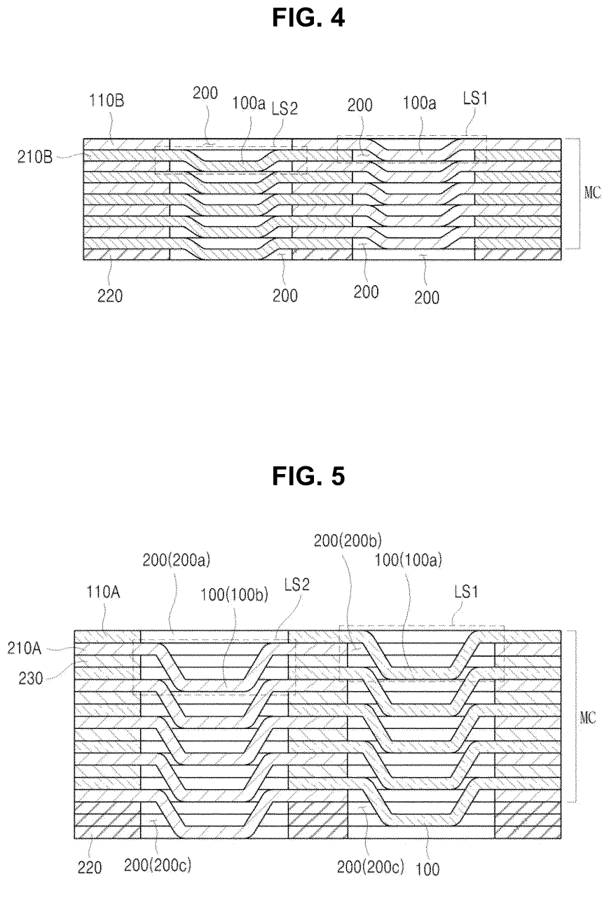

When the height of the protrusion 100 is equal to the thickness of the hole 200 (N=1), the laminated core may have the lamination structure LS shown in FIG. 4, however, the layers fastening force may be weaker compared to the lamination structure shown in FIG. 3 or 5. Each of the laminas for the laminated structure shown in FIG. 3 or 5, has a single protrusion and a single hole, but for improving layers fastening force, it is preferable to use lamina with multiple protrusions and holes.

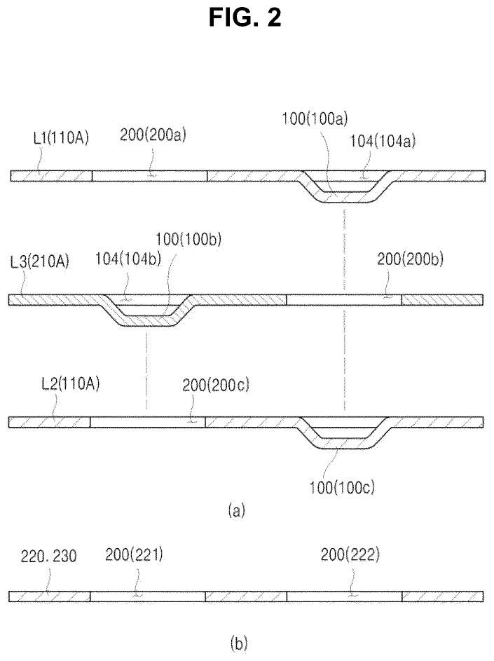

A more specific example of the laminated structure applicable to the Embodiments of the laminated core will be described, with reference to FIG. 2. A split core being a part of a finished core can also be the laminated core according to the present invention.

Referring to FIG. 2, the laminated core is formed by stacking of laminas.

The laminated core includes multiple laminas, each having the protrusion 100 and the holes 200. More particularly, the laminated core includes a plurality of second laminas L3. Each of the second laminas L3 is connecting lamina provided between parallel a first lamina L1 and a third lamina L2 and connects the first lamina L1 and the third lamina L2.

The second lamina has a second hole 200b into which a first protrusion 100a of the first lamina is fitted and a second protrusion 100b fitted into a third hole 200c passing through the third lamina. The protrusion 100b and the hole 200b of the second lamina are formed at different positions.

The first protrusion 100a is fitted into the second hole 200b of the second lamina L3 and form a first connection structure LS1, and the second protrusion 100b of the second lamina is fitted into the third hole 200c and form a second connection structure LS2.

The second lamina L3 is connected to the first lamina L1 and the third limina L3 by the first and second connection structure LS1 and LS2, and forms multiple layers of the laminated core.

The first protrusion 100a has an embossed shape with the concave portion 104 formed at rear side thereof, passes through the hole 200b of the second lamina, and is fixed to a third protrusion 100c of the third lamina by fitting. The first protrusion 100a and the third protrusion 100c are embossed protrusions formed in same direction and having the same shape and size.

A concave portion is formed at a rear side of the third protrusion 100c into which the first protrusion 100a is fitted, and a concave portion 104b is formed at a rear side of the second protrusion 100b.

The first lamina L1 and the third lamina L2 may be the same lamina. That is, the first protrusion 100a and the third protrusion 100c are formed on the same line and in same direction. A first hole 100a is formed through the first lamina L1 on the same line as the third hole 200c.

Therefore, the first protrusion 100a passes through the second hole 200b and is fixed to the third protrusion 100c by fitting.

And the second lamina L3 is repeated a predetermined number of times at a predetermined interval, and the second protrusions are successively connected, thereby forming a laminated body MC shown in FIG. 3B.

When the second lamina L3 is provided on and under the first lamina L1 and the second lamina L3 provided on the first lamina L1 is connected to the first lamina L1 by the second connection structure LS2, the first lamina L1 may also be the connecting lamina.

Similarly, when the second lamina L3 is provided on and under the third lamina L2 and the second lamina L3 provided on the third lamina is connected to the first lamina L2 by the first connection structure LS1, the third lamina L2 may also be the connecting lamina.

According to FIG. 2, the first lamina L1 and the third lamina L2 have the same shape, and the first protrusion 100a and the third protrusion 100c are formed on the same line, but are not limited thereto. For example, the first protrusion 100a may be staggered from the third protrusion 100c. In such a case, a lamina under the third lamina L2 may have a hole aligned with the third protrusion 100c, and the third lamina L2 in such the case may also be the connecting lamina.

At least one layer of an intermediate lamina 230 lamina may be provided between the first lamina L1 and the second lamina L3 and/or between the second lamina L3 and the third lamina L2. The number of the intermediate laminas provided between the first lamina L1 and the second lamina L3 and/or between the second lamina L3 and the third lamina L2 may be varied depending on the height of the first protrusion 100a and the second protrusion 100b.

The intermediate lamina 230 has a communication hole with the same shape and size as the second hole 200b, and the communication hole is aligned with the first protrusion 100a and the second hole 200b.

And, at least one layer of a cover lamina 220 is provided on a first side (bottom side) of the laminated body MC. The covering lamina 220 overlaps with the first side of the laminated body, and finishes the first side, i.e., the bottom side of the laminated core.

The cover lamina 220 has a first finish hole 221 aligned with the third hole 200c and having the same shape and size as the third hole 200c and a second finish hole 222 aligned with the second hole 200b and having the same shape and size as the second hole 200b. That is, the intermediate lamina 230 mat be used as cover lamina 220.

The cover lamina 220 is connected and fixed to the last layer (the lowermost layer) having the protrusion 100 of the laminated core, and prevents the protrusion 100 from protruding from the bottom surface of the laminated core. The number of the cover laminas may be varied depending on the protruding height of the protrusion 100.

Each of the first lamina L1, the second lamina L3, and the third lamina L2 shown in FIG. 2, has a single protrusion and a single hole, however, may have multiple protrusions and holes.

Hereinafter, a lamination structure of the laminated core will be described with reference to FIGS. 3A and 3B.

Referring to FIGS. 3A and 3B, the laminated core according to a first embodiment is a layered structure formed by stacking of laminas and has the lamina connection structure LS! And LS2 using the aforementioned connecting lamina.

The laminas of the first embodiment have first lamias 110A each having a first protrusion 100a and a first hole 200a formed therethrough and second laminas 210A each having a second protrusion 100b and a second hole 200b formed therethrough.

The first protrusion 100a and the first hole 200a are formed at different positions, the second protrusion 100b and a second hole 200b are formed at different positions, and the first protrusion 100a and second protrusion 100b protrude in the same direction, for example, in downward direction.

In this embodiment, the first hole 200a is aligned with the second protrusion 100b, and the first protrusion 100a is aligned with the second hole 200b. The first lamina 110A and the second lamina 210A are stacked alternately. the first laminas 110A and the second laminas 210A form the laminated body MC where the layers of the first laminas 110A are divided by the layers of the second laminas 210A.

That is, the laminated core in this embodiment has a laminated body MC that includes the first laminas 110A and the second laminas 210A. The first laminas 110A have the layers divided by the second laminas. the second laminas 210A also have the layers divided by the first laminas.

More particularly, at least one layer of the first lamina 110A and at least one layer of second lamina 210A may be alternately and repeatedly stacked, but is not limited thereto. For example, as shown in FIG. 3B, the first lamina 110A and second lamina 210A may be alternately stacked the same number of times, or one layer of the first lamina may be directly added to the final layer of the second laminas.

For convenience of description, a top layer and layers with the same shape as the top layer having the protrusion 100 and the hole 200 and connected to a lower adjacent lamina by the first connection structure LS1 are referred to as the first lamina. Therefore, the lamina referred to as first lamina in this specification can also be called second lamina.

Thus, except for the topmost first lamina shown in FIG. 3B, the remaining first laminas may function as the connecting lamina. Similarly, the second lamina shown in FIG. 3B may also be called the connecting lamina.

The first protrusion 100a is an embossed protrusion and has the same shape and size as the second protrusion 100b, and the concave portion is formed on the rear side thereof. Therefore, the first protrusion 100a can be successively connected in a row, and the second protrusion 100b can be successively connected in a row. For aforementioned connection, the first lamina 110A has the same thickness as the second lamina 210A, and the height of the first protrusion may be N times the thickness of the second lamina (N being a natural number greater than or equal to 2).

The holes 200 have a through shape formed by a piercing process. The first laminas and the second laminas may be stacked alternately multiple layers at a time, however, to prevent a gap between layers and improve the quality of the laminated core, such as ensuring the flatness and perpendicularity, it is preferable for the first lamina 110A and the second lamina 210A to be stacked alternately one layer at a time. And, depending on the height of the protrusions 100, the intermediate lamina 230 may be interposed between the first lamina 110A and the second lamina 210A.

At least one layer of the cover lamina 220 is provided on one side of the laminated body MC. More Specifically, when the height of the first and second protrusions are twice (N=2) the thickness of the cover lamina as in FIG. 3B, two layers of the cover laminas 220 are provided on the laminated body. Likewise, when the height of the protrusions is three times (N=3) the thickness of the cover lamina as shown in FIG. 5, three layers of cover laminas 220 are provided on the laminated body, and one layer of the intermediate lamina is interposed between the first and second laminas.

The cover lamina 220 has a first finish hole 221 aligned with the first hole 200a and having the same shape and size as the first hole 200c and a second finish hole 222 aligned with the second hole 200b and having the same shape and size as the second hole 200b.

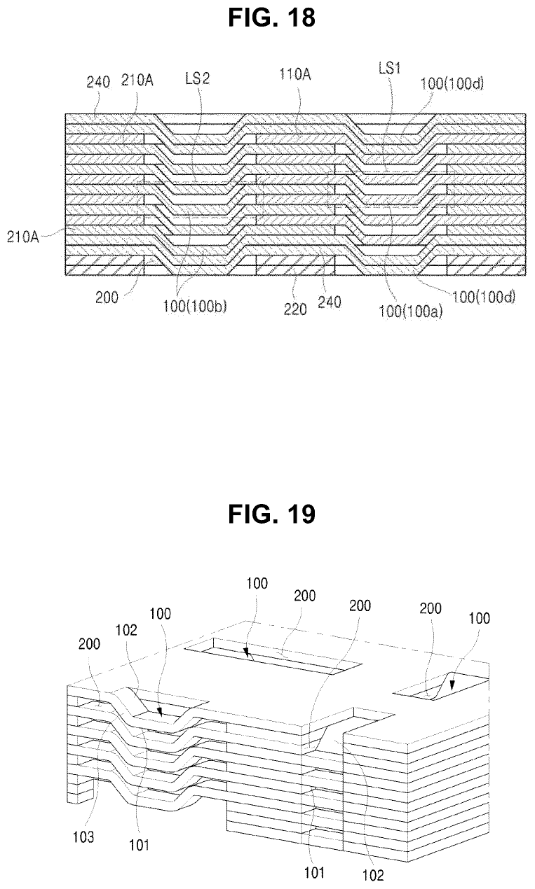

The finish holes of the cover lamina 230 are formed at the same positions as the first protrusion 100a and the first hole 200a, and the cover lamina may prevent the protrusions 100 from protruding from the bottom surface of the laminated core, and separate adjacent laminated cores. The lowest lamina with protrusions may be the first lamina or the second lamina or a reinforcing lamina 240 directly stacked onto the cover lamina as shown in FIGS. 17 and 18.

A least one protrusion 100 and at least one hole 200 may be formed at Each of the first lamina 110A and the second lamina 210A.

The laminated core includes the laminas with both the protrusion 100 and the hole 200. And the positions of the protrusion 100 and the hole 200 of the first lamina are opposite to those of the second lamina.

That is, the second hole 200b is formed at the position of the first protrusion 100a and the second protrusion 100b is formed at the position of the first hole 200a.

When the height of the protrusion 100 is greater than the thickness of the lamina, i.e., the thickness of the connection hole, for example, if it is twice the thickness of the lamina as shown in FIG. 3B, the first protrusions 100a are sequentially connected, each passing through one layer of the second lamina 210A, and the second protrusions 100b are also sequentially connected, each passing through one layer of the first lamina 110A. When the protrusion height is equal to the thickness of the lamina, the laminated core includes laminas 110B and 210B as shown in FIG. 4.

When the protrusion height is greater than three times the thickness of the lamina 210, for example, three times the thickness of the lamina, the intermediate lamina 220 can be provided between the first lamina 110A and the second lamina 210A as shown in FIG. 5.

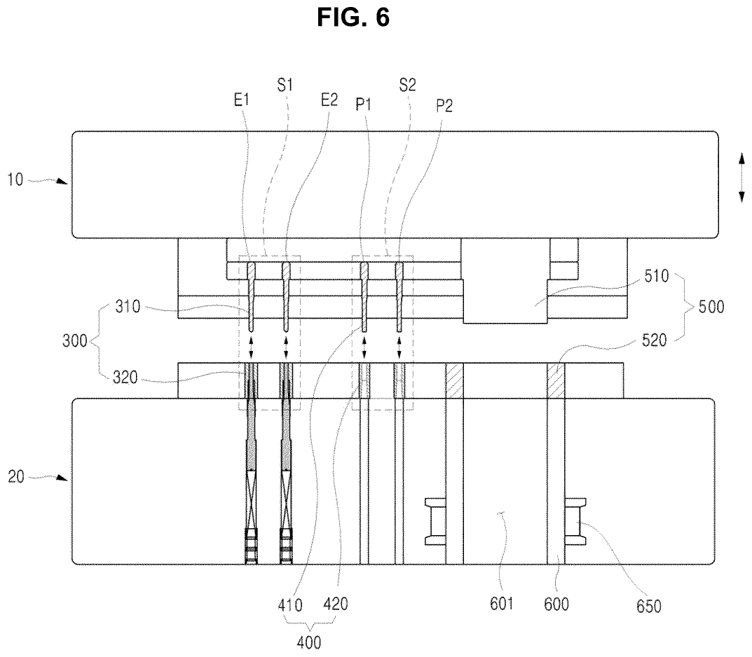

Hereinafter, embodiments of the method and embodiments of the apparatus for manufacturing the laminated core are described with reference to FIGS. 6 to 11.

The method for manufacturing a laminated core formed by alternate stack of laminas, includes step of stacking the first laminas 110A and the second lamina 210A alternately.

More particularly, the method includes step (a) of stacking the second lamina 210A on a cover lamina 220 provided inside a stacking die and forming a lower laminate having a structure where the second lamina are fixed on the cover lamina by fitting, and step (b) of alternately stacking at least one layer of the first layer 110A and at least one layer of the second layer 210A on the lower laminate a predetermined number of times.

The step (a) may include step (a1) of blanking an area of a metal strip where the finish hole is formed that is intermittently transferred by one pitch to form the cover layer 220 and stacking at least one layer of the cover lamina in an inner space (lamination space) 601 of a stacking die, and step (a2) of blanking an area of the metal strip where the second protrusion 100b the second hole 200b are formed so as form and stack at least one layer of the second lamina directly or in directly on at least one layer of the cover lamina.

The step (b) includes a step of forming a lamination structure in which the first protrusions are connected and fixed in a row and the second protrusions are connected and fixed in a row.

The laminated core may be manufactured by various core manufacturing apparatuses. The apparatus for manufacturing various embodiments of the laminated core is a progressive die, which sequentially manufactures laminated cores, machining a metal strip intermittently transferred by a predetermined pitch per stroke of a press.

The apparatus includes an embossing unit 300 configured to press a metal strip to form the embossed protrusion on the metal strip, a piercing unit 400 configured to form the hole in the metal strip, and a blanking unit 500 configured to blank the metal strip.

The piercing unit 400 may be provided upstream or downstream of the embossing unit or in the same area as the embossing unit in a transfer direction of the metal strip, and forms the hole 200 in the metal strip. The blanking unit 500, which is provided downstream of the embossing unit 300 and the piercing unit 400, blanks the metal strip to form the first lamina and the second lamina.

The embossing unit 300 includes an elevatable embossing pin 310 and an embossing die 320 facing the embossing pin 310 and configured to support the metal strip. The piercing portion 400 may include an elevatable piercing punch 410 and a piercing die 420 facing the piercing punch and configured to support the metal strip.

The blanking unit 500 may include an elevatable blanking punch 510 and a blanking die 520 facing the blanking punch, and a stacking die 600 having a space for the laminas L is provided under the blanking die 520. The stacking die 600 may have a rotatable structure.

The embossing pin 310, the piercing punch 410, and the blanking punch 510 may be provided at an elevatable upper die 10, and may be elevated together with the upper die 10. The embossing die 320, the piercing die 420, the blanking die 520, and the stacking die 600 are provided at a lower die 20 facing the upper die 10.

As described above, the stacking die 600 may be rotatably provided in the lower die 20, and the stacking die 600 is provided with a rotation mechanism 650. Examples of the rotating mechanism may be a pulley or ring gear to which a belt for power transmission of a motor is connected or other device capable of indexing. The rotatable stacking die is also called a rotating die, and since the rotating die is known in the art related to the laminated core manufacturing apparatus, a further description of the rotating die will be omitted.

Hereinafter, embodiments of the apparatus for manufacturing the laminated shown in FIGS. 3B and 4, are described.

Referring to FIG. 6, a first embodiment of the apparatus includes a processing stage at which the planed area for blanking is machined, so as to sequentially manufacture laminas.

In the present embodiment, the processing stage includes a first stage S1 and a second stage S2, wherein the embossing unit 300 is provided at the first stage S1, and the piercing unit 400 is provided at the second stage S2.

And the embossing unit 300 may be provided upstream of the piercing unit 400 in the transfer direction of the metal strip, but may be provided downstream of the piercing unit 400 since forming time of the protrusions and the holes may be adjusted by a height adjusting device such as a slide bar 30 mentioned later.

More particularly, the first stage S1 may be provided with a plurality of embossing pins 310. The embossing pins 310 may simultaneously press the planed area for blanking on the first stage S1 to form the first and second protrusions 100a and 100b. The planed area for blanking refers to the expected site that is punched by the blanking punch to form the laminas.

The second stage S2 is provided with piercing punches 410 to simultaneously form a plurality of holes 200 on the second stage once every two-pitch transfer of the metal strip.

The embossing pins 310 and piercing punches 410 are height-adjustably provided at the upper die 10. For example, the embossing pins 310 and piercing punches 410 may be connected to the operation adjuster.

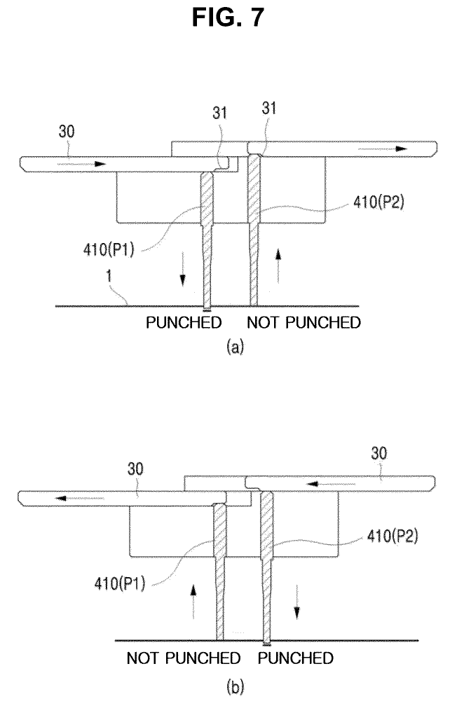

More particularly, as shown in FIG. 7, an elevating device having a slide bar 30 or a slide plate for adjusting the height of the piercing punch 410 may be provided at the upper die.

The slide bar 30 is linearly movably provided at the upper die 10, and a stepped portion 31 is formed at the slide bar 30. As shown in FIG. 7, when an upper end of the piercing punch 410 is pressed downward by the slide bar 30, whereby the piercing punch 410 is located at a lower limit, the metal strip 1 may be punched when the upper die 10 is moved downward.

When the slide bar 30 is moved and the stepped portion 31 of the slide bar is located above the piercing punch 410, pressing contact between the piercing punch 410 and the metal strip is prevented even if the upper die 10 is moved downward.

The piercing punch 410 may be supported by an elastic member such as a spring, etc. The slide bar 30 may be moved linearly by a linear actuator, such as a reciprocating motion device or a cylinder, and the upper die 10 may be provided with a stripper.

Referring to FIG. 7, when both piercing punches P1 and P2 are pressed down by the slide bar 30, the metal strip is punched in the second stage S2 when the upper die 10 is moved downward. And this area processed by the piercing punches may form the cover lamina 220 or the intermediate lamina 230 shown in (c) of FIG. 3A.

Example of the adjuster is not limited to the above-described mechanism and may be changed to a rotation cam, etc. And the adjuster may also be applied to the embossing pin 310.

According to one embodiment of the laminated core manufacturing apparatus, every time the metal strip moves by one pitch, the height of the embossing pins E1 and E2 in the first stage S1 is adjusted alternately so as to sequential form the first protrusion 100a and second protrusion 100b in different blanking planned areas, and the height of the piercing punches P1 and P2 in the second stage S2 is also adjusted alternately so as to sequentially form the first hole 200a and second hole 200b in the different blanking planned areas.

When the cover lamina is to be formed, the embossing pins E1 and E2 are retracted upward and located at the upper limit, and only the piercing punches P1 and P2 may punch the metal strip at the lower limit to form the finish holes for the cover lamina.

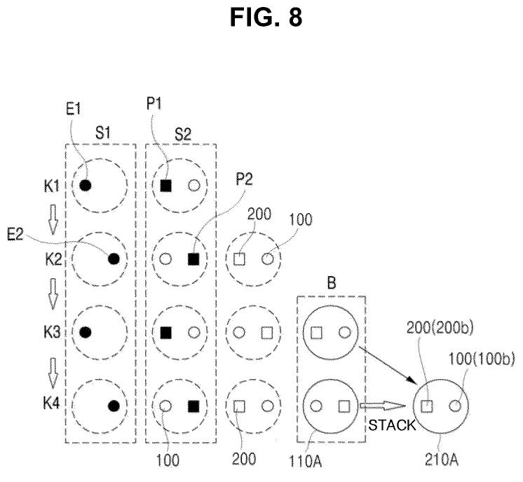

FIG. 8 shows a process for manufacturing the laminated cores shown in FIG. 3B, using the apparatus shown in FIG. 6.

Referring to FIG. 8, each time the metal strip moves by one pitch, the same positions in the different blanking planned areas are processed by the embossing pin and piercing punch, respectively.

More particularly, when the embossing process is performed by the first embossing pin E1 on the first stage S1 to form the protrusion (K1 step), at the same time, the piercing process is carried out on the second stage S2 by the first piercing punch P1. That is, at the K1 step, the second embossing pin E2 and the second piercing punch P2 are raised by the height adjuster.

A step (K2) is a state that the metal strip has moved one pitch from a step (K1), and steps (K3) and (K4) are states that the metal strip has stepwisely moved by one pitch from the step (K2), which are the same in other embodiments described later.

When the metal strip moves by one pitch after the (K1) step, the embossing process is performed on the first stage S1 by the second embossing pin E2 (K2 step), while at the same time, the piercing process is performed on the second stage S2 by the second piercing punch P2. At the K2 step, the first embossing pin E1 and the first piercing punch P1 are raised by the height adjuster.

Then, after the metal strip moves again by one pitch, the same process as the K1 step is repeated on the first and second stages S1 and S2 (K3 step), while the blanking process is carried out on the blanking stage B. The laminas formed by the blanking process form the first lamina 110A or the second lamina 210A inside the stacking die.

After the progress of the K3 step, when the metal strip moves by one pitch, the same process as the aforementioned K2 step is repeated (K4 step) on the first and second stages S1 and S2, and the blanking process is performed on the blanking stage B. The lamina formed by blanking, for example, the first lamina 110A, is stacked onto the previously inputted lamina, for example, the second lamina 210A in the stacking die.

In the subsequent stages, the aforementioned process is repeated over a predetermined period. As a result, a laminated core shown in FIG. 3B, 4 or 5 can be produced, depending on the height of the protrusions. And, it is also obvious that, in order to form the cover lamina, the second stage S2 can be operated alone over a predetermined cycle.

The apparatus and the method for manufacturing the laminated cores shown in FIG. 3B or 4 are not limited to the aforementioned examples and can be modified. For example, by replacing the second embossing pin of the first stage shown in FIG. 6 with a piercing punch, and adjusting the operation timing of the second stage using the height adjuster, a laminated core shown in FIG. 3B, 4 or 5, can also be manufactured.

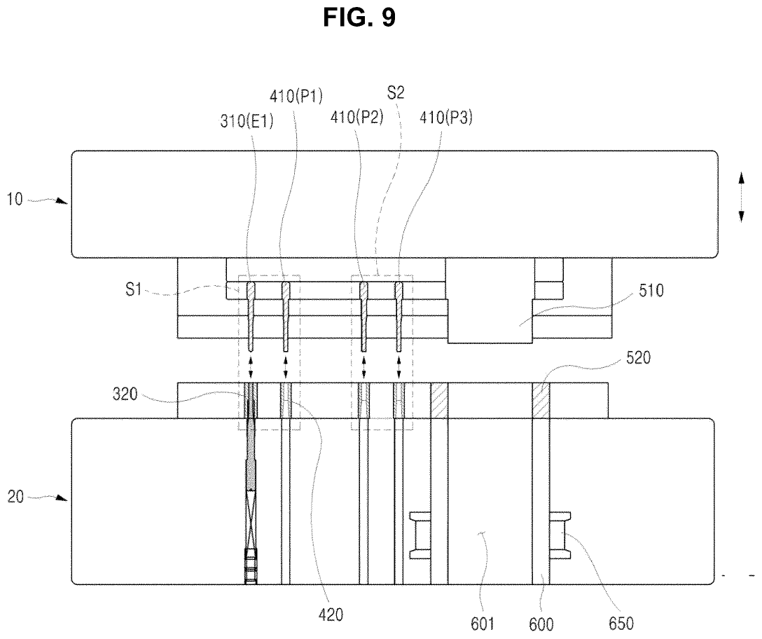

FIG. 9 shows a second embodiment of the apparatus for manufacturing the laminated cores shown in FIG. 3B, 4 or 5. The second embodiment includes a first stage S1 provided with an embossing unit 300 and a piercing unit 400 and a second stage S2 provided with piercing units 300.

More particularly, an embossing pin 310 and a piercing punch 410 are provided at the first stage S1 of the upper die, and piercing punches 410 are provided at the second stage S2 of the upper die. The embossing pin 310 and the piercing punch 410 in the first stage S1 and the piercing punches 410 in the second stage S2 may be height-asjustable by various device such as the height adjuster shown in FIG. 7.

For convenience of description, the embossing pin and the piercing punch of the first stage S1 are referred to as a first embossing pin E1 and a first piercing punch P1, and the piercing punches of the second stage S2 are referred to as a second piercing pin P2 and a third piercing punch P3.

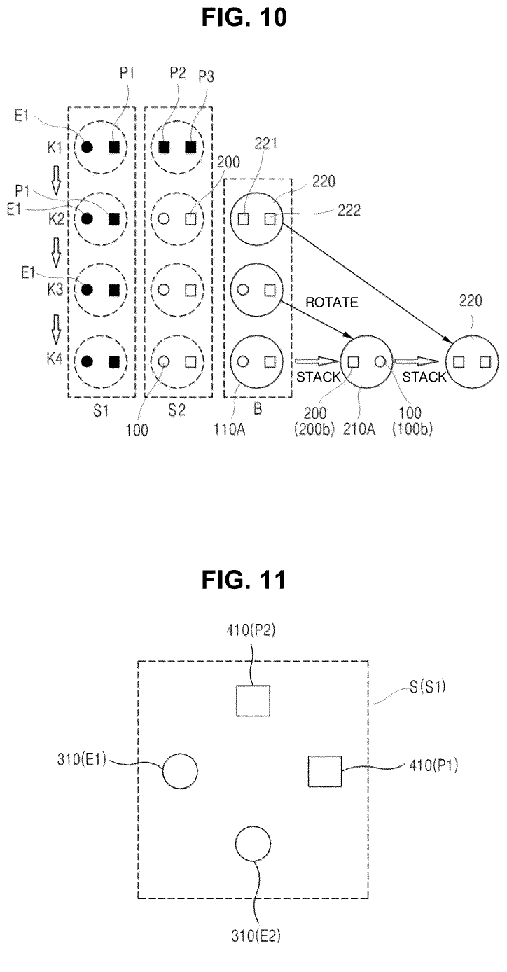

The first stage S1 is provided upstream of the second stage S2. Referring to FIGS. 9 and 10, the first piercing punch P1 and the first embossing pin E1 simultaneously form the protrusion 100 and the hole 200 in a blanking planned area on the first stage S1, when the metal strip moves. The height of the protrusion 100 may vary on the depth of embossing. The depth of embossing may change the connection structure of laminas as shown in FIGS. 3B, 4 and 5.

The second piercing punch P2 and the third piercing punch P3 remain in the idle state, and when the formation of the cover lamina 220 or the intermediate lamina 230 is required, they move to the punching state to form the holes 221 and 222 in the blanking planned area of the second stage S2.

In the (K1) step shown in FIG. 10, the first embossing pin E1 and the first piercing punch P1 of the first stage S1 may form the protrusion 100 and the hole 200 at the blanking planned area on the first stage, while simultaneously in the second stage S2, the second piercing punch P2 and the third piercing punch P3 may form holes for the cover lamina or the intermediate lamina.

And in the following steps (K2) to (K4), forming process of the protrusion 100 and the hole 200 is repeated during a predetermined period so as to make the first lamina 110A and the second lamina 210A.

The Blanking process is performed at the blanking stage B provided at downstream of the second stage, and the lamina with the protrusion and the hole is stacked directly or indirectly on the cover lamina 220 formed by blanking. Then, the stacking die 600 rotates 180° before the next blanking step, so that the second lamina 210A may be formed inside the stacking die 600.

Another lamina with the protrusion 100 and the hole 200 is stacked on the second lamina 210A and may form the first lamina 110A. The protrusion 100a of the first lamina may pass through the second hole 200b to fit into the finish 221 of the cover lamina.

In the subsequent steps, whenever the metal strip moves by one pitch, the stacking die 600 rotates 180° for the alternate stacking step of the first and second laminas. And the (K3) and (K4) steps are repeated over a predetermined cycle, by the rotation of the stacking die. As a result, the alternate stacking of the first and second laminas on the cover lamina can be repeated a predetermined number of times.

In order to form the cover lamina, the second stage S2 can be operated at predetermined times.

FIG. 11 shows a third embodiment of the apparatus for manufacturing the laminated shown in FIGS. 3B, 4 and 5. In this embodiment, height-adjustable embossing pins E1 and E2 and piercing punches P1 and P2 can be provided in a single stage S where the blanking planned area is placed.

For example, as seen from the top of the stage S, the embossing pins E1 and E2 and piercing punches P1 and P2 are arranged as shown in FIG. 11. One of the embossing pins and one of the piercing punches positioned on opposite sides may simultaneously process the blanking planned area on the stage and form both the protrusion 100 and the hole 200 at the blanking planned area.

More particularly, referring to FIG. 11, when a first embossing pin E1 and a first piercing punch P1 are disposed at the lower position, a second embossing pin E2 and a second piercing punch P2 may ascend to the upper position. Contrariwise, when the first embossing pin E1 and the first piercing punch P1 ascend to at the upper position, the second embossing pin E2 and the second piercing punch P2 are disposed at the lower position.

The first stage S1 of the apparatus shown in FIG. 9, can be replaced with the structure shown in FIG. 11. whenever the metal strip moves by one pitch, the stacking die 600 rotates 90° for the alternate stacking step of the first and second laminas. Accordingly, the alternate stacking of the first lamina 110A and the second lamina 210A on the cover lamina can be repeated a predetermined number of times.

In the structure of FIG. 11, the height of the protrusion 100 formed by the embossing pins 410, E1 and E2 may change the connection structure of laminas as shown in FIGS. 3B, 4 and 5.

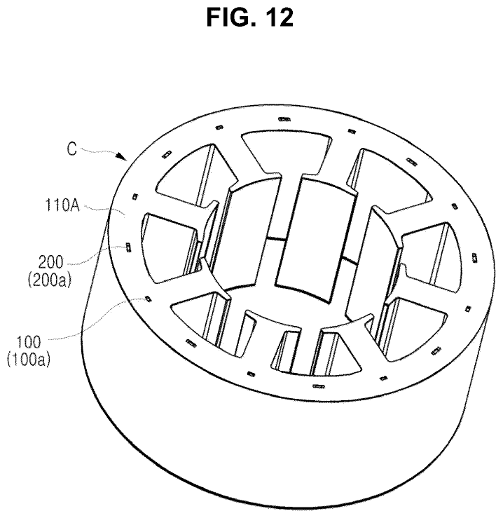

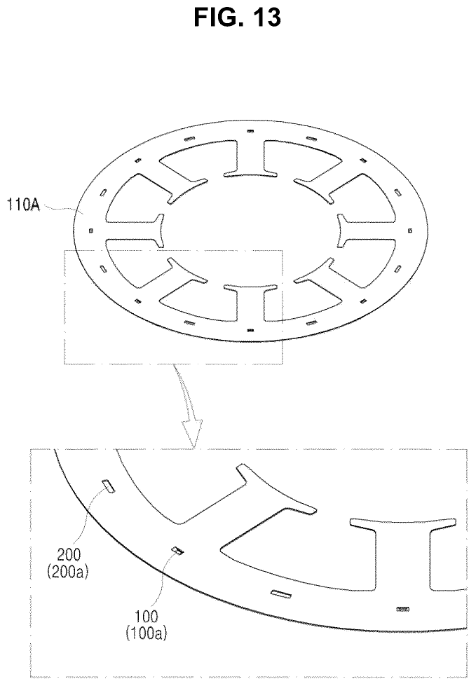

FIG. 12 is a perspective view of a specific embodiment of the laminated core using the structure shown in FIG. 3B. FIGS. 13 to 15 show the laminas for the laminated core of FIG. 12.

Referring to FIGS. 12 to 15, the laminated core C shown in the FIG. 12, includes the first laminas 110A with the first protrusions 100a and the first holes 200a, the second laminas 210A with the second protrusions 100b and the second holes 200b, and the cover lamina 220 being the bottom layer and being configurated to separate adjacent cores.

The protrusions 100a and through-holes 200a of the first lamina 110A are alternately formed along the circumferential direction at a constant radius from the center of the third lamina 110A.

The holes 200b of the second lamina 210A are aligned with the protrusions 100a of the first lamina, and the protrusions 100b of the second lamina 210A are aligned with the through-holes 200a of the first lamina, such that the protrusions 100a of the first lamina 110A are inserted and fitted into the holes 200b of the second lamina 210A, one by one.

When the height of the protrusion 100 is twice the lamina thickness, the laminated core may have a lamination structure shown in FIG. 3B, where the first lamina and the second lamina are alternately and repeatedly stacked.

When the height of the protrusion 100 is twice the lamina thickness, the first lamina and the second lamina are alternately and repeatedly stacked, and the first lamina forms a top surface of the laminated core, the number of the first laminas and the number of the second laminas may be equal or different.

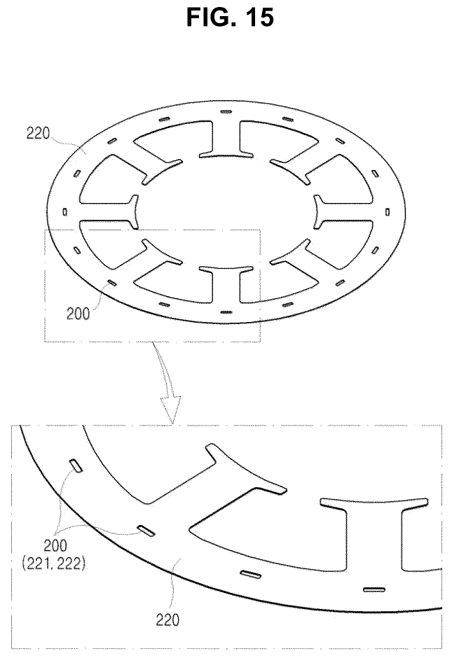

When the protrusion height 100 is twice the lamina thickness, two layers of the cover laminas 220 shown in FIG. 15 are placed at the bottom of the laminated core C2. The cover laminas 220 prevent the protrusions 100 from protruding from the bottom surface of the laminated core and separate adjacent laminated cores.

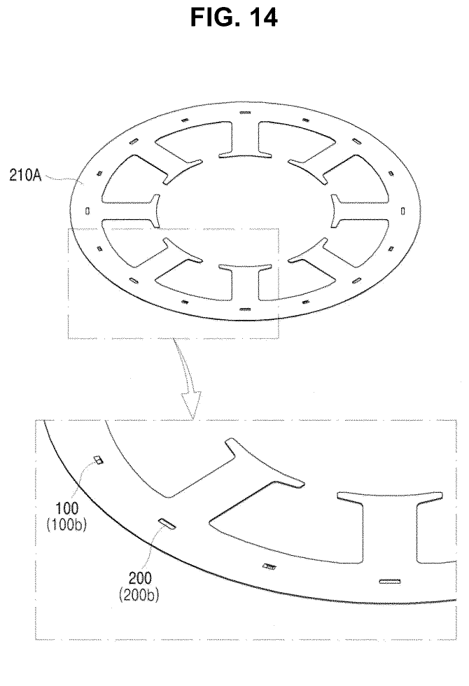

The first lamina 110A and the second lamina 210A may be completely overlapped in the same shape after rotating by a predetermined angle, for example, 180° rotation. The first lamina and the second lamina shown in FIGS. 13 and 14, can be perfectly aligned and overlapped by rotating one lamina by 22.5°.

And at least one layer of reinforcing lamina 240 may be stacked on either the upper or lower side of the laminated body MC formed by the alternate stacking of the first and second laminas, in order to enhance the surface fixing strength.

The reinforcing lamina 240 has protrusions formed at the positions of the first protrusion 100a and the first hole 200a of the first lamina 110A, and this structure is the same as the first lamina shown in FIG. 2.

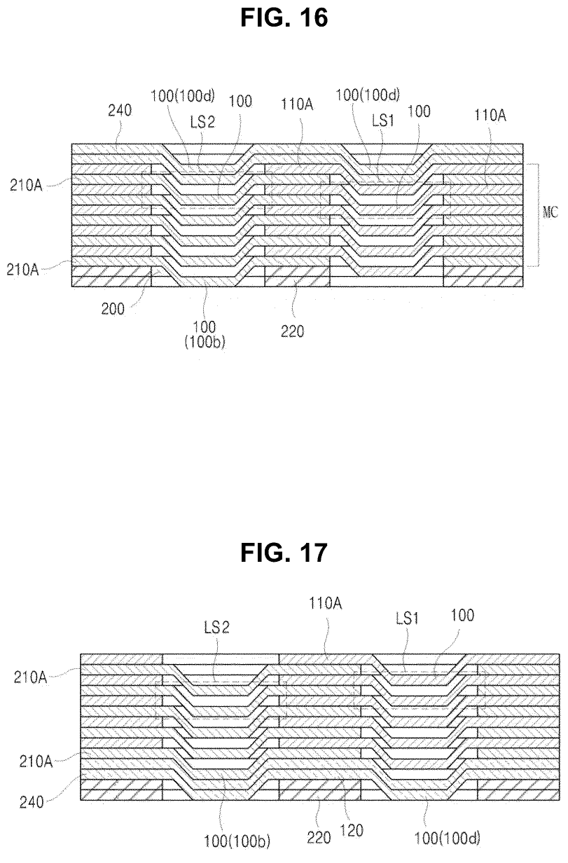

Thus, the reinforcing lamina 240 may form the upper side of the laminated core as shown in FIG. 16, or the reinforcing lamina 240 may be stacked on the cover lamina as shown in FIG. 17, or a structure shown in FIG. 18 by combination of the examples in FIGS. 16 and 17, is also possible. For reference, FIG. 19 shows another example of a laminating structure applicable to the laminated core according to the present invention.

Although the preferred embodiments of the present invention have been disclosed for illustrative purposes, it should be understood by those skilled in the art that these embodiments are given by way of illustration only and the present invention is not limited thereto

Therefore, various modifications, variations, and alterations can be made by those skilled in the art without departing from the spirit and scope of the present invention. And the scope of the invention should be limited only by the accompanying claims and equivalents thereof.

### Industrial Applicability

The present invention related to the core such as a motor or a generator, etc., the laminated core having a structure with layers coupled together by embossed protrusions may be manufactured by a progressive process, and the parallelism, perpendicularity, and flatness of the laminated core may be improved.

1. A laminated core formed by stacking of laminas, wherein the laminas comprise:
a first lamina and a third lamina provided in parallel; and
a plurality of second laminas having a hole into which a first protrusion of the first lamina is fitted and a protrusion fitted into a third hole of the third lamina;
wherein each of the second laminas provided between the first lamina and the third lamina and connecting the first lamina and the third lamina, and the hole and the protrusion of the second lamina formed at different positions.

2. The laminated core according to claim 1, wherein the hole of the second lamina and the first protrusion form a first connection structure, and the protrusion of the second lamina and the third hole of the third lamina form a second connection structure.

3. The laminated core according to claim 1, wherein the first protrusion is configured to pass through the hole of the second lamina and be fixed to a third protrusion formed on the third lamina by fitting, and the first protrusion and the second protrusion have an embossed shape and are formed in same direction.

4. The laminated core according to claim 1, wherein the first and third laminas have the same shape, the laminas further comprise a first hole formed through the first lamina on a same line as the third hole and a third protrusion formed on the third lamina, and the first and third protrusions face a same direction are formed on same line; and
wherein the first protrusion has an embossed shape and is configured to pass through the hole of the second laminas and be fixed to the third protrusion by fitting, the second lamina is repeated a predetermined number of times at a predetermined interval, and the second protrusions are successively connected, thereby forming a laminated body.

5. The laminated core according to claim 1, further comprising at least one layer of an intermediate lamina interposed any one of between the first lamina and the second lamina and between the second lamina and the third lamina.

6-13. (canceled)

14. The laminated core according to claim 2, further comprising at least one layer of an intermediate lamina interposed any one of between the first lamina and the second lamina and between the second lamina and the third lamina.

15. The laminated core according to claim 3, further comprising at least one layer of an intermediate lamina interposed any one of between the first lamina and the second lamina and between the second lamina and the third lamina.

16. The laminated core according to claim 4, further comprising at least one layer of an intermediate lamina interposed any one of between the first lamina and the second lamina and between the second lamina and the third lamina.

17. A laminated core formed by stacking of laminas, comprising:
a laminated body including first laminas having a first hole and a first protrusion and second laminas, each of the first laminas having a first hole and a first protrusion formed at different positions, each of the second laminas having a second hole and a second protrusion formed at different positions, the first and second protrusions protruding in a same direction,
wherein the first hole and the second protrusion are formed on the same line, the first protrusion and the second hole are formed on the same line, the first lamina and the second lamina are alternately stacked, and the first laminas divided by the second laminas.

18. The laminated core according to claim 17, wherein a plurality of the first protrusions are successively connected in a row, and a plurality of the second protrusions are successively connected in a row.

19. The laminated core according to claim 17, wherein a height of the first protrusion is greater than a thickness of the second lamina.

20. The laminated core according to claim 19, wherein the thickness of the second lamina is the same with the first laminas, and the height of the first protrusion is N times the thickness of the second layer (N being a natural number of 2 or more).

21. The laminated core according to claim 18, wherein a height of the first protrusion is greater than a thickness of the second lamina.

22. The laminated core according to claim 21, wherein the thickness of the second lamina is the same with the first laminas, and the height of the first protrusion is N times the thickness of the second layer (N being a natural number of 2 or more).

23. The laminated core according to claim 17, further comprising at least one layer of a cover lamina stacked on a first side of the laminated body and covering to finish the first side of the laminated body.

24. The laminated core according to claim 23, wherein the cover lamina includes;
a first finish hole aligned with the first hole and having the same shape and size as the first hole, and
a second finish hole aligned with the second hole and having the same shape and size as the second hole.

25. The laminated core according to claim 18, further comprising at least one layer of a cover lamina stacked on a first side of the laminated body and covering to finish the first side of the laminated body.

26. The laminated core according to claim 25, wherein the cover lamina includes;
a first finish hole aligned with the first hole and having the same shape and size as the first hole, and
a second finish hole aligned with the second hole and having the same shape and size as the second hole.

27. A method for manufacturing the laminated core formed by stacking of laminas, the laminated core comprising a laminated body including first laminas having a first hole and a first protrusion and second laminas, each of the first laminas having a first hole and a first protrusion formed at different positions, each of the second laminas having a second hole and a second protrusion formed at different positions, the first and second protrusions protruding in a same direction, wherein the first hole and the second protrusion are formed on the same line, the first protrusion and the second hole are formed on the same line, the first lamina and the second lamina are alternately stacked, and the first laminas divided by the second laminas, the method comprising:
(a) stacking the second lamina on a cover lamina provided inside a stacking die and forming a lower laminate having a structure where the second lamina are fixed on the cover lamina by fitting; and
(b) alternately stacking at least one layer of the first layer and at least one layer of the second layer on the lower laminate a predetermined number of times.
